(19) United States
(12) Patent Application Publication
(10) Pub. No.: US 2008/0282186 A1
(43) Pub. Date: Nov. 13, 2008

(54) Keyword generation system and method for online activity

(75) Inventor: Raj Basavaraju, San Diego, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(73) Assignee: Clikpal, Inc.

(21) Appl. No.: 11/801,842

(22) Filed: May 11, 2007

(51) Int. Cl. G06F 3/048

(52) U.S. Cl. 715/781

(57) ABSTRACT

This document discloses a system and method for recording and tagging a user's online activity, manipulating textual representations of the recorded and tagged online activity, and displaying the manipulated textual representations in a window for later use. A graphical representation of keywords determined from online activity between one or more client computers and one or more networks over a time period is generated. Each keyword is assigned at least one graphical attribute according to at least one automatic weighting scheme. A keyword display of the graphical representation is then generated for display in a graphical user interface, the keyword display comprising the keywords, each keyword being formatted for display according to the at least one graphical attribute

### BACKGROUND

This disclosure relates generally to computer communications, and more particularly to tools and techniques for generating keywords related to online activity, and for using the keywords in various later online activities.

Many tools exist for improving online activities. One tool is a tag cloud, which is visual depiction of content “tags” used on a website. A tag is a relevant keyword or term associated with, or assigned to, an item of information such as a section of text, a photo, or a video. A tag describes the item and allows for keyword-based searches on that item and related items that have been similarly tagged. For example, a photo sharing site allows users to provide a “tag” to each photo they post to the site. Each tag is a keyword or category label provided by the user to describe a photo, and allows other users to find groups of photos that have something in common, i.e. share a common tag.

Tags are usually chosen by a user in an informal manner, and are therefore not typically part of a formal or standardized classification scheme. Accordingly, tags often lack meaning or semantic value or distinction. Lack of such semantic distinction can lead to erroneous associations to certain items. For example, a tag of “windows” can be associated with a computer operating system, a piece of glass, an area of a graphical user interface, or any other item.

A tag cloud is a visual depiction of tags associated with a website, particularly a website that provides a large group of similar content such as photos, videos, etc. The tag cloud shows a grouping of relevant tags. The size of a tag reflects its popularity or other such weighting.

### SUMMARY

In general, this document discusses a system and method for recording and tagging a user's online activity, manipulating textual representations of the recorded and tagged online activity, and displaying the manipulated textual representations in a window that can be used later or shared among one or more other users.

In one aspect, a computer-implemented method is disclosed. The method includes generating a graphical representation of keywords determined from online activity between one or more client computers and one or more networks over a time period, where each keyword is assigned at least one graphical attribute according to at least one automatic weighting scheme. The method further includes generating a keyword display of the graphical representation for display in a graphical user interface. The keyword display includes the keywords. Each keyword is formatted for display according to the at least one graphical attribute.

In another aspect, a computer-implemented method includes monitoring online activity of a client computer for a period of time, and determining keywords from websites visited by the client computer during the online activity. The method further includes generating a graphical representation of the keywords, where each keyword is assigned at least one graphical attribute according to at least one automatic weighting scheme.

In yet another aspect, a system for generating keywords related to online activity includes a traffic collector that monitors online activity of a client computer, and a traffic parser that parses HTTP requests from the monitored online activity to generate an HTTP request table. The system includes a content scraper that scrapes and separates, into separate content-based containers of a database, content of each website associated with an HTTP address in the HTTP request table. The system further includes a keyword generator that reads the content from selected content-based containers to determine a number of keywords related to the content.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a functional flow of a keyword generation method and system.

FIG. 2 is a functional block diagram of a computer-implemented keyword generation system.

FIG. 3 is a functional block diagram of a computer-implemented keyword generation system for a consumer-oriented implementation.

FIG. 4 is a screen shot of a graphical user interface displaying a keyword display in a topic page.

FIG. 5 is a screen shot of a graphical user interface displaying a keyword display in a user profile page.

Like reference symbols in the various drawings indicate like elements.

### DETAILED DESCRIPTION

This document describes a computer-implemented keyword generation method and system, as a tool to capture the online activity of one or more users, and focus a history of that online activity in a manner that can be used again for collaboration, focused search, and productivity improvement.

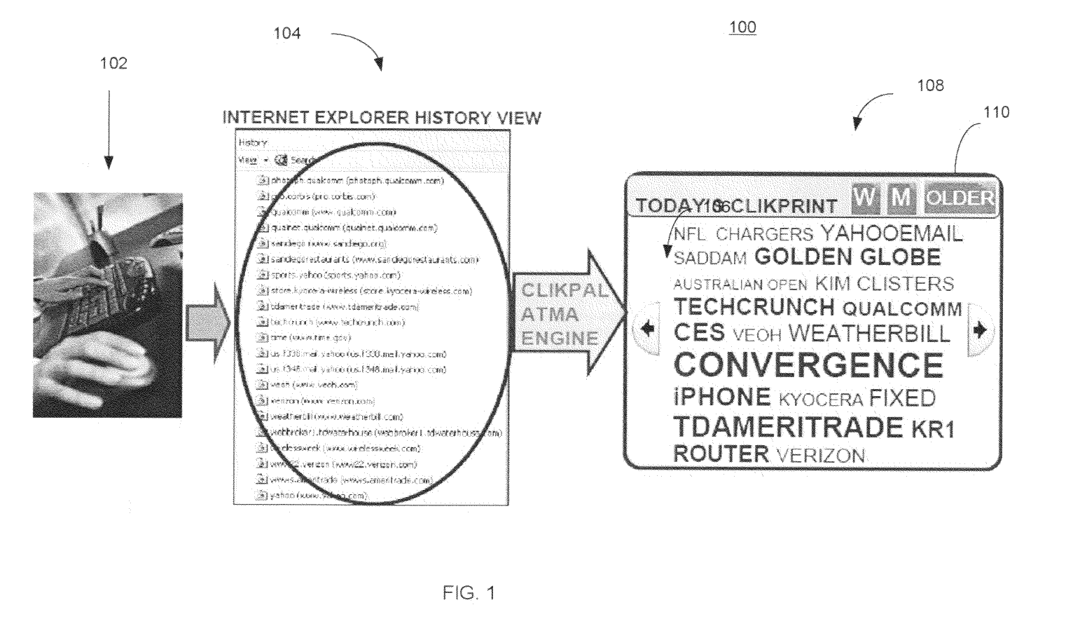

FIG. 1 depicts a functional flow 100 of a keyword generation method and system, in which online activity 102 of a user is monitored and collected by a computer, to generate a history 104 of the online activity within a defined time period. The online activity 102 includes data communicated between one or more networks such as the Internet or World Wide Web, a client computer such as a computer executing a browser program under control of the user, and through which the data is communicated. The defined time period can be set by a user, or automatically determined by the computer. The computer can include a local software agent or external software agent configured to execute the monitoring and collection of data representative of online activity. The software agent can be made up of one or more computer program code modules or objects.

The history 104 of the online activity is processed by an attention tracking and monitoring agents (ATMA) engine 106, having one or more software agents configured to generate a graphical representation 108 of keywords and/or key phrases determined from history 104 of online activity. The ATMA engine 106 assigns each keyword and/or key phrase at least one graphical attribute according to at least one automatic weighting scheme. For example, more prominent key words are assigned larger font sizes. Or, in another example, key phrases related to websites containing a certain threshold of images can be assigned italics for its font attribute.

The graphical representation 108 can be formatted as a display file for display in a graphical user interface or for communication to other client computers and their users. The display file can also be stored, locally or in a central repository, or can be stored in a server system that is part of the one or more networks. The graphical representation can also include functions such as date buttons 110 and/or navigation icons 112, both of which are linked to other graphical representations 108, to access and generate associated display files.

As used herein, the term graphical representation is an assembly of digital data that when converted into a display file can be visualized, i.e. visually displayed on a graphical display to be viewed by a user. Online activity includes activities related to searching one or more networks, such as the Internet (such as “surfing the 'net,”), an Intranet, or local area network (LAN), a wide area network (WAN), or any other network.

The keywords and/or key phrases includes text that makes up words or group of words, or character strings or symbols that can be searched for on a network, or that is related to subject matter or topic that is searched for on a network. Accordingly, a keyword can represent a main topic or set of topics of a page of a website, for example. The term graphical attribute includes a font, font size, a “look and feel” of the graphical representation, or other visual or contextual attribute that can be applied to the graphical elements that make up the graphical representation. A display file includes data that can be processed and executed by machine code to display the graphical representation of the keywords and/or keywords in a graphical user interface (GUI) such as a browser display, graphical window within a GUI, a portal, or the like.

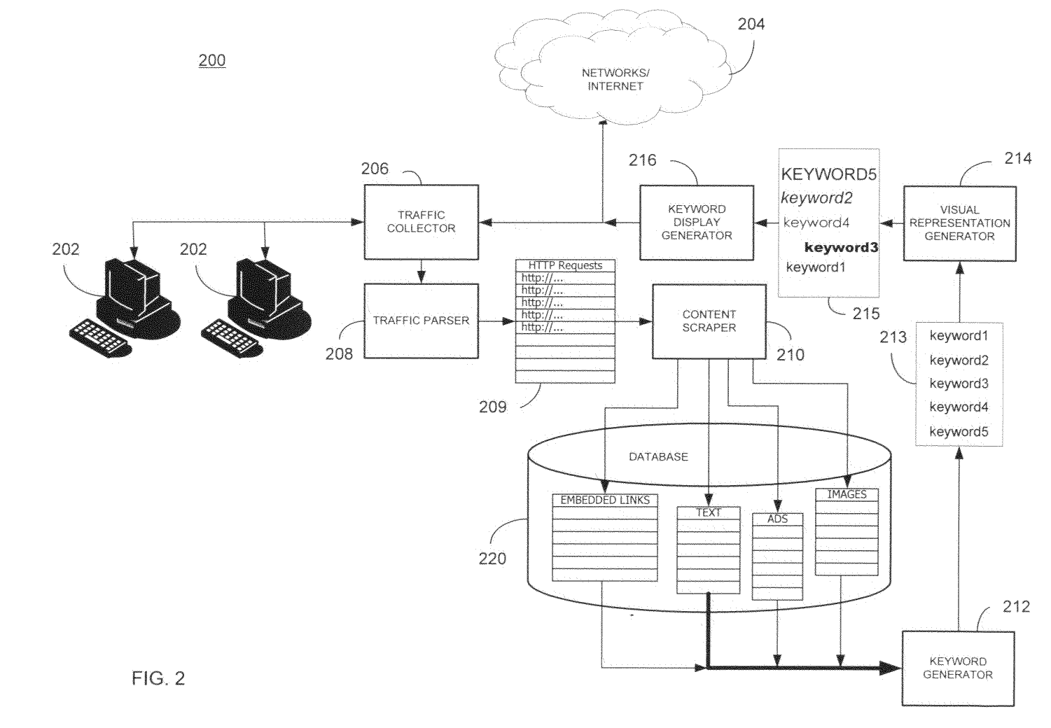

FIG. 2 is a functional block diagram of a computer-implemented keyword generation system 200 for generating historical keywords representing online activity. The keyword generation system 200 is illustrated as an implementation for an enterprise, as but one example. The keyword generation system 200 includes a traffic collector 206, preferably implemented as a software agent but which also can be implemented as a hardware or firmware tool, that is embedded in the system 200 at a point where all the online activity between each client computer 202 and the one or more networks 204 can be monitored. The online activity includes a history of web pages visited at the one or more networks 204. The traffic collector 206 can be configured to monitor the online activity of each client computer 202 individually, or groups of client computers 202 as an aggregate. The monitoring by the traffic collector 206 can be done for any period of time, which period can be set by a user or can be predetermined by the system 200.

The traffic collector 206 presents the history of the online activity to a traffic parser 208 in the form of a log/file of traffic. The traffic parser 208 receives the output of the traffic collector 206 and parses the recorded online activity to separate all hypertext transfer protocol (HTTP) or world wide web (WWW) site requests made from each client computer 202 or groups of client computers 202. The traffic parser 208 parses the log/file of traffic for such requests, and searches for all HTTP requests, which are identified by “http://”. The traffic parser 208 creates an output file/database 209 of HTTP requests that stores all such individual HTTP requests with a date/time stamp and associated user information (i.e. computer name/IP/other unique identifier, etc.). In some implementations, the traffic collector 206 and traffic parser 208 are distinct modules of software code, while in other implementations they can be combined into one software agent, based at least in part on the enterprise system on which the system is employed.

A content scraper 210 receives and reads the output file/database 209 of HTTP requests, and creates a queue of tasks. Each task includes fetching/retrieving a stored HTTP request, loading the unique web page associated with the HTTP request, “scraping” the web page for all the content on that page and storing the content in a space of a database 220 based on the content type. The act of scraping involves reading the entire page and searching for key tags embedded in the page to identify the content types. For example, in one implementation the content scraper 210 scrapes a page based on content types of text, embedded links, advertisements, and images. Other content types are possible, such as videos, graphics, embedded executable programs such as Flash media or GIF files, etc.

A keyword generator 212 reads the content in the database 220 and generates a number of keywords and/or key phrases 213 to represent the topics of interest that correspond to the web activity of the user. The topics can be generated for each individual user of each client computer 202, as well as collectively for an entire enterprise, i.e. for a group of users of one or more of the client computers 202. The keyword generator 212 generates and outputs a ranking of the top keywords with a weight value according to one or more automatic weight schemes. In one implementation, the keyword generator 212 processes the text content in the database 220 (as indicated by the heavy arrow leading from the text table in database 220 in FIG. 2), and generates a list of keywords from the text. The keywords can be weighted according to other information processed from the other content types, such as embedded links, advertisements, and images.

In some implementations, calculating a keyword includes indexing all the words contained on the web page and using an algorithm to generate the top keywords that most likely describe that web page. The algorithm can include a unique set of variables, each variable having an associated weight that generates a rank or weight of each keyword. The variables can include, without limitation: a frequency of words/phrases on each web page or among web pages; whether words or phrases are emphasized on a page in some way, either by placement on a page or font effect such as boldness, font size, etc.; a number of pictures on a page; a number of embedded links on a page; whether words or phrases have attached links; time spent on a particular webpage; advertisements stored in a web page; sequence each page is visited by a user in relation to other pages; and user preferences that may be stored in the system 200.

A visual representation generator 214 receives the keyword ranking and associated weights that are generated from the keyword generator 212 and generates a graphical representation of the weighted keywords as a keyword display 215, the graphical representation including the keywords and the weighting schemes as one or more graphical attributes applied to the keywords For example, the graphical attributes can include font, color, or size of the keyword, which all can be varied to create a unique representation for each keyword based on the associated weights. The visual representation generator 214 also builds a mapping of each keyword with the associated HTTP requests (i.e. a list or a single page) and displays the list of HTTP pages when the corresponding keyword is selected (i.e. “clicked” by a user using a device such as a mouse). Alternatively, the keywords and/or key phrases in the keyword display 215 can be formatted as a link to the most relevant web page or web pages that have been ranked in an order.

The keyword display 215 can be generated as a window in graphical user interface (GUI), i.e. as part of a browser or portal page that is used often by a user. The keyword display 215 can also be formatted as a file that can be communicated to other users over a network, or saved in a memory for being added to or used as a comparison to later online activity or keyword displays.

A keyword display generator 216 generates a display file of the keyword display 215. In some implementations, the keyword display generator 216 is a graphics processor on a computer. In other implementations, the keyword display generator 216 is a software agent running on a server. The keyword display generator 216 manipulates the keyword display 215 for a particular GUI, or packages the keyword display for transmission over a communication link to other client computers 202 or to a server in the one or more networks 204.

The keyword display generator 216 also allows the display file to be manipulated in a variety of ways. For example, the keyword display generator 216 allows the user to rename or retag one or more of the keywords with something different or more appropriate. The keyword display generator 216 also allows for the sharing of all or part of the keyword display 215 with other users in the system 200. The keyword display generator 216 can also offer tools to filter the keyword display 215 based on sharing parameters or user preferences, and to apply further graphical manipulation to the keyword display 215 before it is displayed in a GUI.

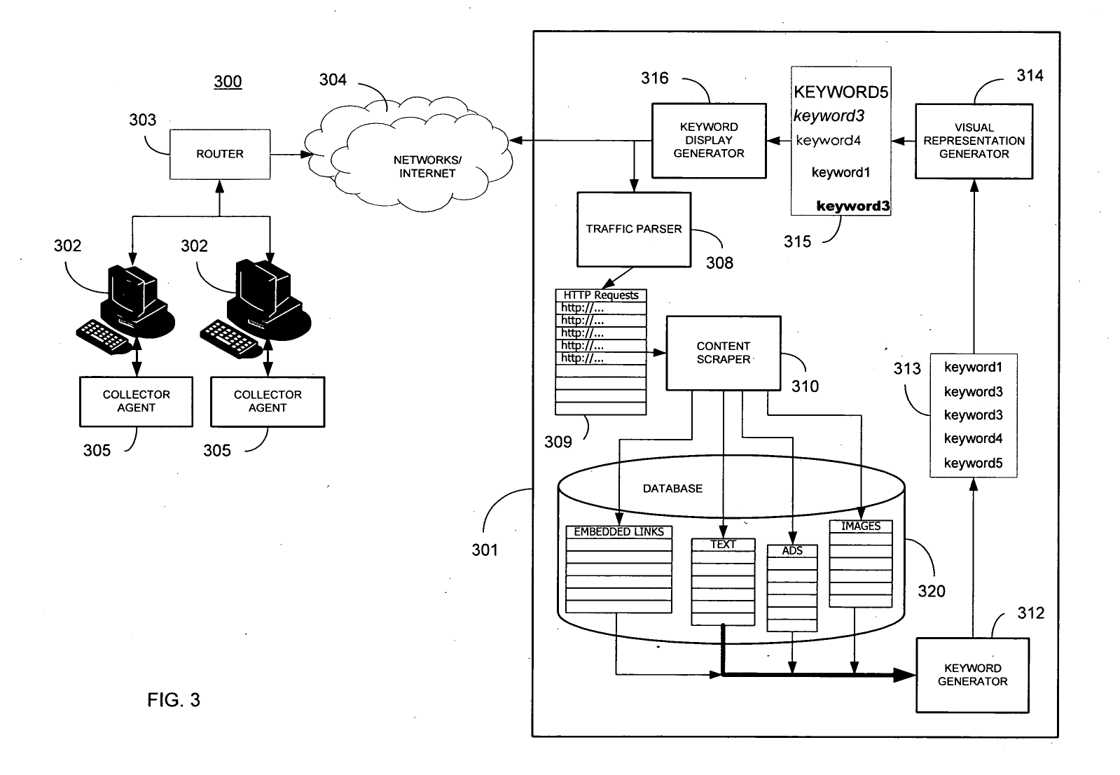

FIG. 3 illustrates a keyword generation system 300 that is suitable for a consumer-oriented (i.e. single user subscriber) implementation. The keyword generation system 300 includes a keyword generation server 301 connected to one or more client computers 302 by one or more networks 304 such as the internet. The one or more client computers 302 can be linked together or to the networks 304 by a router 303.

Each client computer 302 has a collector agent 305, preferably a software agent or executable code running on the client computer. The collector agent 305 is configured to monitor the online activity of the client computer 302 for a period of time and produce a history of the online activity in the form of a log/file. The log/file can be transmitted to the keyword generation server 301 over the networks 304.

The keyword generation server 301 includes a traffic parser 308 that, as described above with reference to traffic parser 208, receives the log/file of the history of online activity, and parses the history of online activity to separate all hypertext transfer protocol (HTTP) or world wide web (WWW) site requests made from the associated client computer 302. The traffic parser 308 parses the log/file of traffic for such requests, and searches for all HTTP requests, which are identified by “http://”. The traffic parser 308 creates an output file/database 309 of HTTP requests that stores all such individual HTTP requests with a date/time stamp and associated user information (i.e. computer name/IP/other unique identifier, etc.).

A content scraper 310 receives and reads the output file/database 309 of HTTP requests, and creates a queue of tasks. Similar as described above, each task includes fetching/retrieving a stored HTTP request, loading the unique web page associated with the HTTP request, “scraping” the web page for all the content on that page and storing the content in a space of a database 320 based on the content type.

A Keyword generator 310 reads the content in the database 320 and generates a number of keywords and/or key phrases 313 to represent the topics of interest that correspond to the web activity of the user. The keyword generator 310 generates and outputs a ranking of the top keywords with a weight value according to one or more automatic weight schemes. In some implementations, the keyword generator 310 processes the text content in the database 320 (as indicated by the heavy arrow leading from the text table in database 320 in FIG. 3), and generates a list of keywords from the text. The keywords can be weighted according to other information processed from the other content types, such as embedded links, advertisements, and images.

As similarly described above, calculating a keyword includes indexing all the words contained on the web page and using an algorithm to generate the top keywords that most likely describe that web page. The algorithm can include a unique set of variables, each variable having an associated weight that generates a rank or weight of each keyword. A visual representation generator 314 receives the keyword ranking and associated weights that are generated from the keyword generator 312 and generates a graphical representation of the weighted keywords as a keyword display 315, the graphical representation including the keywords and the weighting schemes as one or more graphical attributes applied to the keywords.

The visual representation generator 314 also builds a mapping of each keyword with the associated HTTP requests (i.e. a list or a single page) and displays the list of HTTP pages when the corresponding keyword is selected (i.e. “clicked” by a user using a device such as a mouse). Alternatively, the keywords and/or key phrases in the keyword display 315 can be formatted as a link to the most relevant web page or web pages that have been ranked in an order. The keyword display 315 can be generated for display in a window in graphical user interface (GUI), i.e. as part of a web page served to the client computer 302 from the keyword generation server 301 or other server. The keyword display 315 can also be formatted as a file that can be communicated to other users over a network, or saved in a memory for being added to or used as a comparison to later online activity or keyword displays.

A keyword display generator 316 generates a display file of the keyword display 315, and manipulates the keyword display 315 for a particular GUI. The keyword display generator 316 can also package the keyword display for transmission over a communication link to other client computers 302 or to another server connected with the one or more networks 304. The keyword display generator 316 also allows the display file to be manipulated in a variety of ways, substantially as described above with respect to the keyword display generator 216.

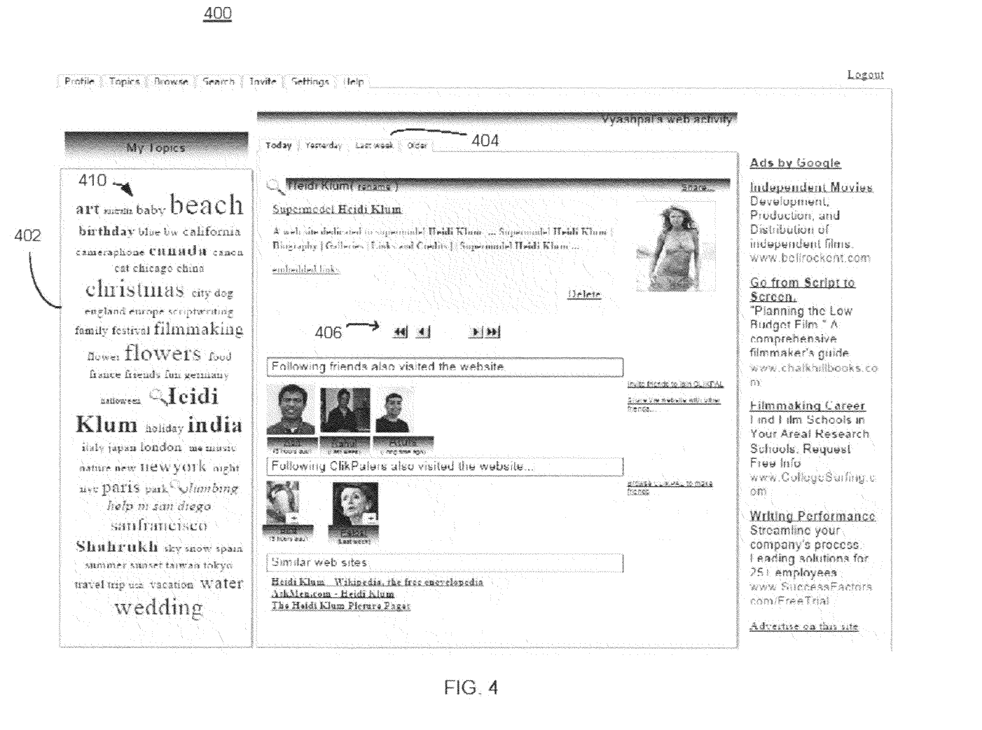

FIG. 4 depicts a screen shot of a GUI 400 displaying a keyword display 402 in a topic page. The GUI 400 is shown as a web page or portal page that can be displayed in a browser or other type of application program. The keyword display 402 can be displayed as a window or section of the GUI 400. The GUI 400 may include tabs 404 or other selectable links to a keyword display 402 corresponding to different time periods, i.e. one day, previous day, week, month, or older. The GUI 400 can also include controls 406 such as user-selectable buttons associated with the keyword display 402 for navigation among a number of different keyword displays 402.

The keyword display 402 is a graphical representation of one or more keywords 410 as individual words or phrases, that are determined from online activity between one or more client computers and one or more networks over a time period. Each of the keywords 410 is individually assigned at least one graphical attribute according to at least one automatic weighting scheme, and forms a link to a group of relevant web pages or HTTP records.

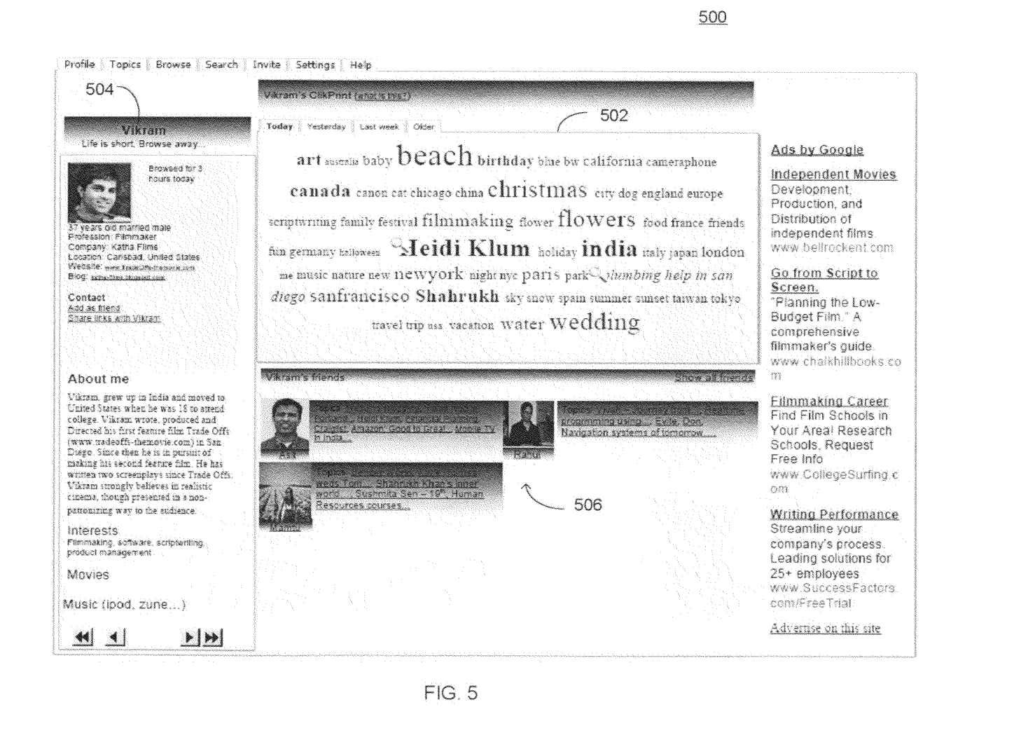

FIG. 5 depicts a screen shot of a GUI 500 displaying a keyword display 502 in a user profile page. The GUI 500 includes a user profile section 504. The keyword display 502 is related to the user profiled in the user profile section 504, or may be otherwise related to other users listed in a “friends” section 506 of the GUI 500. Thus, users can access other user's keyword displays 502, for any time or time period, in addition to profile information of the other users. Accordingly, keyword displays 502 representing a history of online activity can be shared among users to foster collaboration, communication, and networking.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A computer-implemented method, comprising:
generating a graphical representation of keywords determined from online activity between one or more client computers and one or more networks over a time period, each keyword being assigned at least one graphical attribute according to at least one automatic weighting scheme; and
generating a keyword display of the graphical representation for display in a graphical user interface, the keyword display comprising the keywords, each keyword being formatted for display according to the at least one graphical attribute.

2. A computer-implemented method in accordance with claim 1, further comprising monitoring the online activity for one or more variables that are used to determine the keywords, and used by the at least one automatic weighting scheme.

3. A computer-implemented method in accordance with claim 2, wherein the one or more variables are determined from content of one or more web pages visited during the online activity, the variables selected from a group of variables consisting of: frequency of words and/or phrases; graphically emphasized words and/or phrases; number of pictures; number of embedded links; words or phrases with attached links; number of advertisements; time spent on a particular web page; and sequence of each page visited relative to all of the one or more web pages.

4. A computer-implemented method in accordance with claim 3, wherein the one or more variables are based on user preferences stored on the one or more client computers.

5. A computer-implemented method in accordance with claim 1, further comprising parsing the online activity that has been monitored into a list of HTTP requests from the one or more client computers to the one or more networks.

6. A computer-implemented method in accordance with claim 5, further comprising scraping content from web pages on the list of HTTP requests into one or more content-based storage containers of a database.

7. A computer-implemented method in accordance with claim 6, further comprising reading the content from selected content-based storage containers to determine the keywords.

8. A computer-implemented method in accordance with claim 7, further comprising assigning, to each keyword, the at least one graphical attribute according to at the least one automatic weighting scheme.

9. A computer-implemented method in accordance with claim 8, further comprising displaying the keyword display of the graphical representation in a graphical user interface.

10. A computer-implemented method in accordance with claim 8, further comprising storing the keyword display in a database.

11. A computer-implemented method comprising:
monitoring online activity of a client computer for a period of time;
determining keywords from websites visited by the client computer during the online activity; and
generating a graphical representation of the keywords, each keyword being assigned at least one graphical attribute according to at least one automatic weighting scheme.

12. A computer-implemented method in accordance with claim 11, further comprising generating a keyword display of the graphical representation for display in a graphical user interface, the keyword display comprising the keywords, each keyword being formatted for display according to the at least one graphical attribute.

13. A computer-implemented method in accordance with claim 12, further comprising monitoring the online activity for one or more variables that are used to determine the keywords, and used by the at least one automatic weighting scheme.

14. A computer-implemented method in accordance with claim 13, wherein the one or more variables are determined from content of one or more web pages visited during the online activity, the variables selected from a group of variables consisting of: frequency of words and/or phrases; graphically emphasized words and/or phrases; number of pictures; number of embedded links; words or phrases with attached links; number of advertisements; time spent on a particular web page; and sequence of each page visited relative to all of the one or more web pages.

15. A computer-implemented method in accordance with claim 14, wherein the one or more variables are based on user preferences associated with the client computer.

16. A system for generating keywords related to online activity, the system comprising:
a traffic collector that monitors online activity of a client computer;
a traffic parser that parses HTTP requests from the monitored online activity to generate an HTTP request table;
a content scraper that scrapes and separates, into separate content-based containers of a database, content of each website associated with an HTTP address in the HTTP request table; and
a keyword generator that reads the content from selected content-based containers to determine a number of keywords related to the content.

17. A system in accordance with claim 16, further comprising a visual representation generator that applies one or more graphical attributes to each keyword to generate a graphical representation of the keywords.

18. A system in accordance with claim 17, further comprising a keyword display generator that displays the graphical representation of the keyword in a graphical user interface.

19. A system in accordance with claim 18, wherein each keyword in the graphical representation is formatted for display according to its associated one or more graphical attributes.

20. A system in accordance with claim 17, wherein the one or more graphical attributes are selected from a group of attributes consisting of: font, font size, color, boldness, italics, capitalization, and special effect.
